(19) United States
(12) Patent Application Publication
(10) Pub. No.: US 2016/0260984 A1
(43) Pub. Date: Sep. 8, 2016

(54) CARBON-SUPPORTED CATALYST

(71) Applicant: TOYOTA JIDOSHA KABUSHIKI KAISHA, Toyota-shi, Aichi (JP)

(72) Inventors: Mayumi YAMADA, Mishima-shi, Shizuoka-ken (JP); Noriyuki KITAO, Toyota-shi, Aichi-ken (JP); Makoto ADACHI, Toyota-shi, Aichi-ken (JP); Keiichi KANEKO, Toyota-shi, Aichi-ken (JP)

(73) Assignee: TOYOTA JIDOSHA KABUSHIKI KAISHA, Toyota-shi, Aichi-ken (JP)

(21) Appl. No.: 15/029,022

(22) PCT Filed: Aug. 25, 2014
(86) PCT No.: PCT/JP2014/072188

§ 371 Date: Apr. 13, 2016

(30) Foreign Application Priority Data
Oct. 18, 2013 (JP) 2013-217399

(51) Int. Cl. H01M 4/92; H01M 4/86

(52) U.S. Cl. CPC H01M 4/926; H01M 4/8657

(57) ABSTRACT

The present invention is to provide a carbon-supported catalyst which has better catalytic performance than conventional carbon-supported catalysts. Disclosed is a carbon-supported catalyst, wherein the carbon-supported catalyst contains fine catalyst particles, each of which contains a palladium-containing particle and a platinum-containing outermost layer covering the palladium-containing particle, and a carbon carrier on which the fine catalyst particles are supported; wherein the carbon-supported catalyst is produced through the synthesis of the fine catalyst particles by (1) preparing the carbon carrier on which the palladium-containing particles are supported, (2) depositing a copper monatomic layer on the palladium-containing particles by copper underpotential deposition, and (3) substituting the copper monatomic layer with the platinum-containing outermost layer; and wherein, in a titration curve obtained by a potentiometric titration method in which a potential is measured by adding an acid solution drop by drop to a mixture of the carbon-supported catalyst and an alkali solution, an amount of change in the potential with respect to an amount of the acid solution added drop by drop in a range where the potential is 0.095 to 0.105 V (vs. Ag/AgCl) is 0.8 (dV/d (mL/m²)) or more.

### TECHNICAL FIELD

The present invention relates to a carbon-supported catalyst which has better catalytic performance than conventional carbon-supported catalysts.

### BACKGROUND ART

As an electrode catalyst for the anode and cathode of a fuel cell, a technique relating to fine catalyst particles is known, which has a structure that includes a core particle and an outermost layer covering the core particle (so-called “core-shell structure”). For the fine catalyst particles, the cost of the inside of the particles, which hardly participate in a catalyst reaction, can be reduced by the use of a relatively inexpensive material for the core particle.

In Patent Literature 1, a method for producing a core-shell catalyst (platinum-covered palladium) is described, the method including a step of mixing a platinum complex salt, which is capable of dissociation into platinum complex cations, and palladium, which is supported on a carrier, in a solution. In the patent literature, it is described that a platinum/palladium core-shell catalyst with a high platinum coverage can be provided.

### CITATION LIST

Japanese Patent Application Laid-Open No. 2012-120949

### SUMMARY OF INVENTION

### Technical Problem

Under “Examples” of Patent Literature 1, the coverage of the surface of palladium with platinum is measured by infrared (IR) spectroscopy, and the platinum coverage is calculated. However, as a result of studies, the inventors of the present invention have found that in addition to the platinum coverage, impurities on the catalyst surface have an influence on catalytic activity. Regarding such an influence of the impurities on the catalyst surface, there has been no clear indicator that is easy to measure.

The present invention was achieved in light of the above circumstance. An object of the present invention is to provide a carbon-supported catalyst which has better catalytic performance than conventional carbon-supported catalysts.

### Solution to Problem

The carbon-supported catalyst of the present invention is a carbon-supported catalyst, wherein the carbon-supported catalyst contains fine catalyst particles, each of which contains a palladium-containing particle and a platinum-containing outermost layer covering the palladium-containing particle, and a carbon carrier on which the fine catalyst particles are supported; wherein the carbon-supported catalyst is produced through the synthesis of the fine catalyst particles by (1) preparing the carbon carrier on which the palladium-containing particles are supported, (2) depositing a copper monatomic layer on the palladium-containing particles by copper underpotential deposition, and (3) substituting the copper monatomic layer with the platinum-containing outermost layer; and wherein, in a titration curve obtained by a potentiometric titration method in which a potential is measured by adding an acid solution drop by drop to a mixture of the carbon-supported catalyst and an alkali solution, an amount of change in the potential with respect to an amount of the acid solution added drop by drop in a range where the potential is 0.095 to 0.105 V (vs. Ag/AgCl) is 0.8 (dV/d (mL/m²)) or more.

In the titration curve of the present invention, the amount of change in the potential with respect to the amount of the acid solution drop by drop in a range where the potential is 0.080 to 0.120 V (vs. Ag/AgCl) is preferably 0.8 (dV/d (mL/m²)) or more.

In the titration curve of the present invention, the amount of change in the potential with respect to the amount of the acid solution drop by drop in a range where the potential is 0.050 to 0.150 V (vs. Ag/AgCl) is preferably 0.8 (dV/d (mL/m²)) or more.

In the titration curve of the present invention, the amount of change in the potential with respect to the amount of the acid solution drop by drop in a range where the potential is −0.020 to 0.020 V (vs. Ag/AgCl) is preferably 2 (dV/d (mL/m²)) or more.

In the present invention, the alkali solution is preferably a mixed solution of 99.5% ethanol and an alkali aqueous solution obtained by mixing a 0.1 M KNO₃ aqueous solution and a 0.5 M KOH aqueous solution; a pH of the alkali aqueous solution is preferably 12; and a molar ratio of water and ethanol in the alkali solution is preferably water:ethanol=4:1.

In the present invention, a solution temperature of the alkali solution is preferably 25° C. at the time of conducting the potentiometric titration method.

In the present invention, an inert gas is preferably bubbled into the alkali solution.

In the present invention, the acid solution is preferably 0.05 M sulfuric acid.

### Advantageous Effects of Invention

According to the present invention, the amount of change in the potential with respect to the amount of the acid solution added drop by drop in at least a range of 0.095 to 0.105 V (vs. Ag/AgCl), is sufficiently large; therefore, impurities and functional groups on the surface of the carbon-supported catalyst, which are reactive with the acid solution added drop by drop in the potentiometric titration method, are less than ever before. As the result, it has better catalytic performance compared to carbon-supported catalysts including conventional core-shell catalysts.

### BRIEF DESCRIPTION OF DRAWINGS

FIG. 1 is a schematic sectional view of a titrator 100.

FIG. 2 is a flow chart of a typical example of the steps from the preparation of a catalyst suspension to the analysis of a titration curve in the present invention.

FIG. 3 is a graph of the potentiometric titration curves of Example 1 and Comparative Example 1.

FIG. 4 is a graph of the potentiometric titration curves of Example 2 and Comparative Examples 2 and 3.

FIG. 5 is a graph of the amount of change in potential with respect to the amount of an acid solution added drop by drop, for the carbon-supported catalysts of Examples 1 and 2 and Comparative Examples 1 to 3, and the range of the horizontal axis is 0.050 to 0.150 V (vs. Ag/AgCl).

FIG. 6 is a graph of the amount of change in potential with respect to the amount of an acid solution added drop by drop, for the carbon-supported catalysts of Examples 1 and 2 and Comparative Examples 1 to 3, and the range of the horizontal axis is 0.080 to 0.120 V (vs. Ag/AgCl).

FIG. 7 is a graph of the amount of change in potential with respect to the amount of an acid solution added drop by drop, for the carbon-supported catalysts of Examples 1 and 2 and Comparative Examples 1 to 3, and the range of the horizontal axis is 0.095 to 0.105 V (vs. Ag/AgCl).

FIG. 8 is a graph of FIG. 5 enlarged in the vertical axis direction.

FIG. 9 is a graph of FIG. 6 enlarged in the vertical axis direction.

FIG. 10 is a graph of FIG. 7 enlarged in the vertical axis direction.

FIG. 11 is a graph of the amount of change in potential with respect to the amount of an acid solution added drop by drop, for the carbon-supported catalysts of Example 1 and Comparative Example 1, and the range of the horizontal axis is −0.02 to 0.02 V (vs. Ag/AgCl).

FIG. 12 is a bar graph comparing the cell voltages of the membrane electrode assemblies of Example 1 and Comparative Example 1.

FIG. 13 is a bar graph comparing the mass activities of the carbon-supported catalysts of Example 2 and Comparative Examples 2 and 3.

### DESCRIPTION OF EMBODIMENTS

The carbon-supported catalyst of the present invention is a carbon-supported catalyst, wherein the carbon-supported catalyst contains fine catalyst particles, each of which contains a palladium-containing particle and a platinum-containing outermost layer covering the palladium-containing particle, and a carbon carrier on which the fine catalyst particles are supported; wherein the carbon-supported catalyst is produced through the synthesis of the fine catalyst particles by (1) preparing the carbon carrier on which the palladium-containing particles are supported, (2) depositing a copper monatomic layer on the palladium-containing particles by copper underpotential deposition, and (3) substituting the copper monatomic layer with the platinum-containing outermost layer; and wherein, in a titration curve obtained by a potentiometric titration method in which a potential is measured by adding an acid solution drop by drop to a mixture of the carbon-supported catalyst and an alkali solution, an amount of change in the potential with respect to an amount of the acid solution added drop by drop in a range where the potential is 0.095 to 0.105 V (vs. Ag/AgCl) is 0.8 (dV/d (mL/m²)) or more.

As described above, for core-shell catalysts, for example, the degree of covering of the core metal surface with the shell metal or the method for directly evaluating the relationship between the catalyst performance and the surface properties of the fine catalyst particles and carbon carrier, is not known yet. Also, a clear indicator of how core-shell catalysts can be improved so that they can exhibit higher activity, is not known yet.

As an indicator for evaluating the completeness of core-shell catalysts, for example, the coverage of the core metal with the shell metal is known. As a method for evaluating the coverage, the measurement of the electrochemical surface area (hereinafter may be referred to as ECSA) of core-shell catalysts is conventionally known. As a method for measuring the ECSA, a method for calculating the ECSA based on cyclic voltammogram (hereinafter may be referred to as CV) waveforms is widely known. The ECSA is a surface area that is standardized in terms of per unit mass (cm²/g). Accordingly, the whole surface area of an electrode catalyst having a certain ECSA can be calculated by multiplying the ECSA value by the total mass of the electrode catalyst. Also, it is widely carried out that a particle size defined in some way, such as the average particle diameter of the electrode catalyst, is measured and the surface area of the electrode catalyst is calculated based on the particle size.

For conventional platinum and platinum alloy catalysts, the whole of each catalyst has a uniform elemental composition. Accordingly, regardless of the presence of convex and concave portions on the catalyst surface, the catalyst surface area can be calculated using measurement results such as CV. However, the outermost surface of conventional core-shell catalysts is composed of a part which is covered with the shell and a part where the core is exposed (that is, defective part of the shell). Accordingly, the CV waveforms of core-shell catalysts are a synthetic product of a waveform derived from the shell and a waveform derived from the part where the core is exposed. Even of the ECSA is calculated based on the CV waveform of a core-shell catalyst itself, the surface area of only the shell of the core-shell catalyst cannot be calculated based on the ECSA. Therefore, it is considered to be quite difficult to quantitate the coverage of core-shell catalysts.

In general, a core-shell catalyst is not used as an electrode catalyst by itself, and it is commonly supported on a carrier such as a carbonaceous material when it is used. Therefore, it makes sense to evaluate the catalytic activity of the core-shell catalyst while it is in the state of being supported on a carbon carrier. As with the part where the core is exposed, the condition of the carbon carrier surface also has a significant influence on catalytic activity. However, for the condition of the carbon carrier surface, any useful information is not obtained except an electrical double layer region shown by a CV waveform, and the condition cannot be detected by conventional electrochemical measurements.

As the result of diligent research, the inventors of the present invention have found that as an indicator for the completeness, etc., of a carbon-supported catalyst that contains fine catalyst particles having a core-shell structure, not only the information on the part which is covered with a platinum-containing outermost layer, but also the information on the part where a palladium-containing particle, which will be the core, is exposed or on the carbon carrier surface supporting the fine catalyst particles are necessary, and they sought a method that can directly evaluate the properties of the surface of the carbon-supported catalyst. As the result, the inventors of the present invention have found a method that can correctly evaluate the completeness of fine catalyst particles based on a potentiometric titration method, and they finally achieved the present invention.

In the present invention, “palladium-containing particle” is a general term for palladium and palladium alloy particles.

As will be described below, the outermost layer covering the palladium-containing particle contains platinum. Platinum is excellent in catalytic activity, especially in oxygen reduction reaction (ORR) activity. While the lattice constant of platinum is 3.92 Å, the lattice constant of palladium is 3.89 Å, and this is a value that is within a range of 5% either side of the lattice constant of platinum. Accordingly, no lattice mismatch occurs between platinum and palladium, and palladium is sufficiently covered with platinum.

In the present invention, from the viewpoint of cost reduction, it is preferable that the palladium-containing particles contain a metal material that is less expensive than the below-described material which is used for the platinum-containing outermost layer. It is more preferable that the palladium-containing particles contain a metal material which is able to impart electroconductivity.

In the present invention, from the above viewpoint, it is preferable that the palladium-containing particles are palladium particles or particles of an alloy of palladium and a metal such as cobalt, iridium, rhodium or gold. In the case of using palladium alloy particles, the palladium alloy particles can contain palladium and only one kind of metal, or they can contain palladium and more kinds of metals.

The average particle diameter of the palladium-containing particles is not particularly limited, as long as it is equal to or less than the average particle diameter of the below-described fine catalyst particles. The average particle diameter of the palladium-containing particles is preferably 30 nm or less, more preferably 2 to 10 nm, from the point of view that the ratio of surface area to cost per palladium-containing particle is high and the ECSA per unit mass of the platinum which constitutes the carbon-supported catalyst becomes high.

In the present invention, the average particle diameter of the palladium-containing particles, the fine catalyst particles and the carbon-supported catalyst is calculated by a conventional method. An example of the method for calculating the average particle diameter of the palladium-containing particles, the fine catalyst particles and the carbon-supported catalyst is as follows. First, for a particle shown in a TEM image at a magnification of 400,000 to 1,000,000×, the particle diameter is calculated, on the assumption that the particle is spherical. Such a particle diameter calculation by TEM observation is carried out on 200 to 300 particles of the same type, and the average of the particles is regarded as the average particle diameter.

In the present invention, the platinum-containing outermost layer on the fine catalyst particle surface preferably has high catalytic activity. As used herein, “catalytic activity” refers to the activity which is required of a fuel cell catalyst, especially oxygen reduction reaction (ORR) activity.

The platinum-containing outermost layer can contain platinum only, or it can contain platinum and iridium, ruthenium, rhodium or gold. In the case of using a platinum alloy for the platinum-containing outermost layer, the platinum alloy can contain platinum and only one kind of metal, or it can contain platinum and two or more kinds of metals.

From the point of view that the elution of the palladium-containing particles can be more inhibited, the coverage of the palladium-containing particle with the platinum-containing outermost layer is generally 0.5 to 2, preferably 0.8 to 1. When the coverage of the palladium-containing particle with the platinum-containing outermost layer is less than 0.5, the palladium-containing particle is eluted in an electrochemical reaction and, as a result, the fine catalyst particles may deteriorate.

As used herein, the “coverage of the palladium-containing particle with the platinum-containing outermost layer” means the ratio of the area of the palladium-containing particle covered with the platinum-containing outermost layer, on the assumption that the total surface area of the palladium-containing particle is 1. An example of the method for calculating the coverage will be described below. First, an outermost layer metal content (A) in the fine catalyst particle is measured by inductively coupled plasma mass spectrometry (ICP-MS), etc. Meanwhile, the average particle diameter of the fine catalyst particles is measured with a transmission electron microscope (TEM), etc. From the average particle diameter thus measured, the number of atoms on the surface of a particle having the same diameter is estimated, and an outermost layer metal content (B) in the case where one atomic layer on the particle surface is substituted with the metal contained in the platinum-containing outermost layer, is estimated. The value obtained by dividing the outermost layer metal content (A) by the outermost layer metal content (B) is the “coverage of the palladium-containing particle with the platinum-containing outermost layer”.

The platinum-containing outermost layer covering the palladium-containing particle is preferably a monatomic layer. The fine catalyst particle having such a structure is advantageous in that, compared to a fine catalyst particle having a platinum-containing outermost layer that is composed of two or more atomic layers, the catalytic performance of the platinum-containing outermost layer is much higher and, since the amount of the platinum-containing outermost layer covering the palladium-containing particle is small, the material cost is lower.

The lower limit of the average particle diameter of the fine catalyst particles is preferably 2.5 nm or more, more preferably 3 nm or more. The upper limit is preferably 40 nm or less, more preferably 10 nm or less.

By the use of the carbon carrier, when the carbon-supported catalyst of the present invention is used in the electrocatalyst layer of a fuel cell, electroconductivity can be imparted to the electrocatalyst layer.

Concrete examples of carbonaceous materials that can be used as the carbon carrier include electroconductive carbonaceous materials including carbon particles and carbon fibers, such as Ketjen Black (product name; manufactured by: Ketjen Black International Company), Vulcan (product name; manufactured by: Cabot Corporation), Norit (product name; manufactured by: Norit), Black Pearls (product name; manufactured by: Cabot Corporation), Acetylene Black (product name; manufactured by: Chevron) and OSAB (product name; manufactured by: Denki Kagaku Kogyo Kabushiki Kaisha).

The carbon-supported catalyst of the present invention is preferably for use in fuel cells. From the viewpoint of excellent oxygen reduction activity, the carbon-supported catalyst of the present invention is preferably used in electrodes for fuel cells, more preferably in cathode electrodes for fuel cells.

Hereinafter, the steps of method for producing the carbon-supported catalyst of the present invention will be described.

First, a carbon carrier on which palladium-containing particles are supported, is prepared. The palladium-containing particles can be those prepared through the following potential applying step (A).

### (A) Potential Applying Step

The potential applying step is a step of applying a potential to the palladium-containing particles.

By the potential applying step, impurities such as oxides (e.g., palladium oxide) can be removed from the surface of the palladium-containing particles. More specifically, oxides can be eluted by applying a potential. As the result, the surface of the palladium-containing particles can be uniformly covered with the platinum-containing outermost layer.

As the acid solution, for example, there may be mentioned a solution containing at least one selected from the group consisting of sulfuric acid, perchloric acid, nitric acid, hydrochloric acid and phosphoric acid. Of them, sulfuric acid is particularly preferred.

As the palladium-containing particles, as described above, at least one selected from palladium particles and palladium alloy particles can be used.

The palladium-containing particles can be particles prepared in advance or a commercially-available product.

The average particle diameter of the palladium-containing particles can be also measured by X-ray diffraction (XRD). As a concrete example of the average particle diameter measurement by XRD, there may be mentioned the following method, for example.

Metal particles are irradiated with X-rays. From diffraction images thus obtained, the crystallite sizes of the particles are obtained by the following Scherrer equation (1). The average value of the thus-obtained crystallite sizes is regarded as the average particle diameter.

D=(Kλ)/(βcosΘ) [Equation (1)]

In the equation (1), the meanings of the reference characters are as follows.

D: Crystallite size (nm)

K: Scherrer constant

λ: Measurement X-ray wavelength (nm)

β: Full-width at half maximum (rad)

Θ: Bragg angle of diffraction line (rad)

The palladium-containing particles are supported on the carbon carrier. Because the palladium-containing particles are supported on the carbon carrier, a potential can be efficiently applied to the palladium-containing particles in the potential applying step. Also in the below-described covering step, a potential can be efficiently applied to the palladium-containing particles. Accordingly, there is such an advantage that the covering of the surface of the palladium-containing particles with the platinum-containing outermost layer can be carried out efficiently. Concrete examples of the carbon carrier are as described above.

The average particle diameter of the carbon carrier is not particularly limited. It is preferably 0.01 to several hundred micrometers (μm), more preferably 0.01 to 1 μm. When the average particle diameter of the carbon carrier is less than the range, the carbon carrier may corrode and deteriorate, and the palladium-containing particles supported on the carbon carrier may be detached over time. When the average particle diameter of the carbon carrier is above the range, the specific surface area may be small, and the dispersibility of the palladium-containing particles may decrease.

The specific surface area of the carbon carrier is not particularly limited. It is preferably 50 to 2000 m²/g, more preferably 100 to 1600 m²/g. When the specific surface area of the carbon carrier is less than the range, the dispersibility of the palladium-containing particles in the carbon carrier may decrease, and sufficient battery performance may not be exhibited. When the specific surface area of the carbon carrier is above the range, the effective utilization rate of the palladium-containing particles may decrease, and sufficient battery performance may not be exhibited.

The rate of the supported palladium-containing particles by the carbon carrier [{(the mass of the palladium-containing particles)/(the mass of the palladium-containing particles+the mass of the electroconductive carrier)}×100%] is not particularly limited. In general, it is preferably in a range of 20 to 60%. When the amount of the supported palladium-containing particles is too small, sufficient catalytic function may not be exhibited. On the other hand, when the amount of the supported palladium-containing particles is too large, no particular problem may occur from the viewpoint of catalytic function; however, even if an excessive amount of the palladium-containing particles are supported on the carbon carrier, it becomes difficult to obtain effects that are commensurate with an increase in production cost.

The palladium-containing particle-supported product in which the palladium-containing particles are supported on the carbon carrier, can be a commercially available product or can be synthesized. As a method for allowing the palladium-containing particles to be supported on the carrier, a conventionally-used method can be employed. For example, there may be mentioned the following method: a carrier dispersion in which the carbon carrier is dispersed is mixed with the palladium-containing particles, and the mixture is filtered, washed, re-dispersed in ethanol or the like and then dried with a vacuum pump, etc. After drying the mixture, the resultant can be heated as needed. In the case of using palladium alloy particles, the palladium alloy particles are allowed to be supported on the carrier concurrently with the synthesis of the alloy.

In the present invention, applying a potential to the palladium-containing particles means imparting a potential to the palladium-containing particles. As used herein, the potential encompasses not only a certain value of potential but also a potential that is variable over time. In the present invention, therefore, applying a potential encompasses sweeping a potential in a predetermined range.

The method for applying a potential to the palladium-containing particles is not particularly limited. A general method can be employed, as long as a potential can be applied to the palladium-containing particles while the particles are in the state of being immersed in the acid solution.

For example, there may be mentioned a method in which a working electrode, a counter electrode and a reference electrode are immersed in a palladium-containing dispersion of the palladium-containing particles dispersed in the acid solution, and a potential is applied to the working electrode. The palladium-containing particles can be immersed and dispersed in the acid solution by adding the palladium-containing particles being in a powdery state to the acid solution. Or, the palladium-containing particles can be immersed and dispersed in the acid solution by adding the palladium-containing particles being dispersed in a solvent to the acid solution. As the solvent, for example, water or an organic solvent can be used. The solvent can also contain an acid. As the acid, those exemplified above as the acid solution can be used. The method for dispersing the palladium-containing particles in the acid solution is not particularly limited. For example, there may be mentioned stirring with a magnetic stirrer.

Also, there may be mentioned a method in which the palladium-containing particles are fixed on an electroconductive substrate or on the working electrode, and a potential is applied to the electroconductive substrate or the working electrode while the palladium-containing particle fixing side of the electroconductive substrate or working electrode is in the state of being immersed in the acid solution. As the method for fixing the palladium-containing particles, for example, there may be mentioned a method in which a palladium-containing particle paste is prepared using an electrolyte resin (e.g., Nafion (product name)) and a solvent such as water or alcohol, and the paste is applied to the surface of the electroconductive substrate or working electrode.

As the working electrode, for example, there may be used a material that can ensure electroconductivity, such as metal material (e.g., titanium) and electroconductive carbonaceous material (e.g., glassy carbon and carbon plate). A reaction container can be formed from such an electroconductive material and used as the working electrode. In the case where a reaction container formed from a metal material is used as the working electrode, from the viewpoint of preventing corrosion, the inner wall of the reaction container is preferably coated with at least one selected from the group consisting of polymer coats containing RuO₂ and carbon.

As the counter electrode, for example, there may be used platinum black, a platinum mesh plated with platinum black, carbon, and carbon fiber materials.

As the reference electrode, there may be used a reversible hydrogen electrode (RHE), a silver-silver chloride electrode, a silver-silver chloride-potassium chloride electrode, etc.

As a potential applying device, there may be used a potentiostat, a potentio-galvanostat, etc.

The range of the swept potential is not particularly limited. It is preferably 0.05 to 1.2 V (vs. RHE).

The number of potential sweep cycles is not particularly limited. It is preferably 1,000 cycles or more, more preferably 1,200 cycles or more. A main purpose of the potential sweep is to clean the surface of the palladium-containing particles and the surface of the carbon carrier.

In the potential applying step, it is preferable to stir the acid solution appropriately, as needed. For example, when the reaction container that functions as the working electrode is used and the palladium-containing particles are immersed and dispersed in the acid solution in the reaction container, by stirring the acid solution, the palladium-containing particles can be brought into contact with the surface of the reaction container (working electrode) and uniform potential can be applied to the palladium-containing particles. In this case, the stirring can be carried out continuously or intermittently in the potential applying step.

### (B) Covering Step

The covering step is a step of covering the surface of the palladium-containing particles with the platinum-containing outermost layer. More specifically, it is a process of synthesizing the fine catalyst particles having a core-shell structure, by depositing a copper monatomic layer on the palladium-containing particles by copper underpotential deposition (deposition step) and then substituting the copper monatomic layer with the platinum-containing outermost layer (substitution step).

Hereinafter, the deposition step (B-1) and the substitution step (B-2) will be described.

### (B-1) Deposition Step

The deposition step is a step of depositing a copper monatomic layer on the surface of the palladium-containing particles by copper underpotential deposition, by applying a potential that is nobler than the oxidation-reduction potential of copper to the palladium-containing particles in a copper ion-containing acid solution that contains copper ions.

A copper monatomic layer can be deposited on the surface of the palladium-containing particles by applying a potential that is nobler than the oxidation-reduction potential (equilibrium potential) of copper to the palladium-containing particles in the state of being in contact with the copper ion-containing acid solution (for example, being immersed in the acid solution).

At this time, the method for bringing the palladium-containing particles into the copper ion-containing acid solution is not particularly limited.

For example, the palladium-containing particles can be immersed and dispersed in the copper ion-containing acid solution by adding the palladium-containing particles being in a powdery state to the copper ion-containing acid solution. Or, the palladium-containing particles can be immersed and dispersed in the copper ion-containing acid solution by adding the palladium-containing particles being dispersed in a solvent to the copper ion-containing acid solution. As the solvent, for example, water or an organic solvent can be used. The palladium-containing particle dispersion is allowed to contain an acid that can be added to the below-described copper ion-containing acid solution.

Also, the palladium-containing particles can be fixed on an electroconductive substrate or on the working electrode, and the palladium-containing particle fixing side of the electroconductive substrate or working electrode can be immersed in the copper ion-containing acid solution. As the method for fixing the palladium-containing particles, for example, there may be mentioned a method in which a palladium-containing particle paste is prepared using an electrolyte resin (e.g., Nafion (product name)) and a solvent such as water or alcohol, and the paste is applied to the surface of the electroconductive substrate or working electrode.

The copper ion-containing acid solution is not particularly limited, as long as it is an acid solution that can deposit copper on the surface of the palladium-containing particles.

In general, the copper ion-containing acid solution is composed of an acid solution in which a certain amount of copper salt is dissolved. However, the copper ion-containing acid solution is not particularly limited to this configuration, and it is needed to be an acid solution in which part or all of the copper ions are dissociated and exist.

The acid used for the copper ion-containing acid solution is not particularly limited, as long as it is an acid. It is preferably an acid that contains at least one selected from the group consisting of sulfuric acid, perchloric acid, nitric acid, hydrochloric acid and phosphoric acid. Of them, sulfuric acid is particularly preferred.

As the copper salt, there may be mentioned copper sulfate, copper nitrate, copper chloride, copper chlorite, copper perchlorate, copper oxalate, etc.

In the copper ion-containing acid solution, the copper ion concentration is not particularly limited. It is preferably 10 to 400 mM.

The counter anions in the copper salt and those in the acid can be the same or different.

It is preferable to bubble an inert gas into the copper ion-containing acid solution in advance. As the inert gas, nitrogen gas, argon gas or the like can be used.

The method for applying a potential that is nobler than the oxidation reduction potential of cooper to the palladium-containing particles, is not particularly limited, and a general method can be employed. For example, there may be mentioned a method in which a working electrode, a counter electrode and a reference electrode are immersed in a copper ion-containing solution in which the palladium-containing particles are immersed, and a potential that is nobler than the oxidation reduction potential of copper is applied to the working electrode. As the working electrode, the counter electrode and the reference electrode, those used in the above-described potential applying step can be used.

The applied potential is not particularly limited, as long as it is a potential that can deposit copper on the surface of palladium-containing particles, that is, a potential that is nobler than the oxidation reduction potential of copper. For example, the applied potential is preferably 0.8 to 0.35 V (vs. RHE), particularly preferably 0.4 V (vs. RHE).

The potential applying time is not particularly limited. It is preferably 2 hours or more, particularly preferably 15 hours or more. More preferably, the potential is kept applied until the reaction current becomes steady and close to zero.

In the case of carrying out the potential applying step and the deposition step in the same reaction container, the copper salt or the copper ion-containing acid solution can be added to the acid solution used in the potential applying step. For example, in the case where sulfuric acid is used as the acid solution in the potential applying step, the deposition step can be carried out by adding a copper sulfate aqueous solution to the sulfuric acid used. The counter anions in the acid solution and those in the copper ion-containing acid solution can be the same or different.

From the viewpoint of stability of the plated metal, it is preferable to carry out the deposition step under an inert gas atmosphere such as nitrogen atmosphere.

Also in the deposition step, it is preferable to appropriately stir the copper ion-containing acid solution, as needed. For example, when the reaction container that functions as the working electrode is used and the palladium-containing particles are immersed and dispersed in the acid solution in the reaction container, by stirring the acid solution, the palladium-containing particles can be brought into contact with the surface of the reaction container (working electrode) and uniform potential can be applied to the palladium-containing particles. In this case, the stirring can be carried out continuously or intermittently in the deposition step.

### (B-2) Substitution Step

The substitution step is a step of substituting copper with platinum by bringing the palladium-containing particles on which the copper monatomic layer is deposited, into contact with a platinum ion-containing acid solution.

In the substitution step, the method for substituting the copper deposited on the surface of the palladium-containing particles with platinum is not particularly limited. In general, due to a difference in ionization tendency, the copper can be substituted with platinum by bringing the platinum ion-containing acid solution with the palladium-containing particles on which the copper monatomic layer is deposited.

The platinum-ion containing acid solution is not particularly limited, as long as it is an acid solution that can substitute copper with platinum. In general, the platinum-ion containing acid solution is composed of an acid solution in which a certain amount of platinum salt is dissolved. However, the platinum-ion containing acid solution is not particularly limited to this configuration, and it is needed to be an acid solution in which part or all of the platinum ions are dissociated and exist.

As the platinum salt used for the platinum ion-containing acid solution, for example, K₂PtCl₄ and K₂PtCl₆ can be used. Also, ammonia complexes such as ([PtCl₄] [Pt(NH₃)₄]) can be used.

In the platinum ion-containing acid solution, the platinum ion concentration is not particularly limited. It is preferably 1 to 5 mM.

The acid which can be used for the platinum ion-containing acid solution is the same as the acid used for the copper ion-containing acid solution. It is preferably an acid that contains at least one selected from the group consisting of sulfuric acid, perchloric acid, nitric acid, hydrochloric acid and phosphoric acid. Sulfuric acid is particularly preferred.

From the viewpoint of uniformly dispersing the platinum ions, the platinum ion-containing acid solution preferably contains citric acid and a hydrate thereof, citric salt and EDTA, etc., in addition to the acid and the salt of the metal catalyst.

The platinum ion-containing acid solution is sufficiently stirred in advance. From the viewpoint of the safety of the plated metal, it is preferable to bubble an inert gas such as nitrogen gas into the acid solution in advance.

The substitution time (time for which the metal catalyst ion containing-acid solution is in contact with the palladium-containing particles) is not particularly limited. It is preferably 120 minutes or more.

In the case of carrying out the deposition step and the substitution step in the same reaction container, the platinum salt and the platinum ion-containing acid solution can be added to the copper ion-containing acid solution used in the deposition step. For example, it is allowed that after the deposition step, the potential control is stopped, and the platinum ion-containing acid solution is added to the copper ion-containing acid solution used in the deposition step, thereby bringing the palladium-containing particles on which copper is deposited, into contact with the platinum ion-containing acid solution.

### (C) Other Steps

In the present invention, a bubbling step can be provided prior to the potential applying step.

The bubbling step is a step of bubbling a reducing gas into the acid solution in which the palladium-containing particles are immersed.

By the bubbling step, the palladium oxide on the surface of the palladium-containing particles can be reduced to palladium, or oxygen on the surface of the palladium-containing particles can be removed. Therefore, a shell can be more uniformly deposited on the palladium-containing particles in a covering step.

The method for bubbling the reducing gas into the acid solution is not particularly limited, and a general method can be employed. For example, there may be mentioned a method in which a reducing gas inlet tube is immersed in the acid solution in which the palladium-containing particles are immersed, and the reducing gas is introduced from a reducing gas supply source and bubbled into the acid solution.

The reducing gas is not particularly limited, and there may be mentioned hydrogen gas, carbon monoxide gas, nitric oxide gas, etc.

The bubbling time is not particularly limited. It is preferably 30 to 240 minutes. The gas flow rate is not particularly limited. It is preferably 10 to 200 cm³/min.

Preferably, the bubbling step is carried out under an inert gas atmosphere such as nitrogen atmosphere.

The bubbling step and the above-described potential applying step can be carried out in the same reaction container.

In the case of using hydrogen gas as the reducing gas, in order to remove oxygen as much as possible from the acid solution in advance, it is preferable to bubble the inert gas into the acid solution, before the reducing gas is bubbled thereinto. Regardless of the type of the reducing gas, by bubbling the inert gas in advance, impurities can be removed on the surface of the palladium-containing particles.

It is also preferable to bubble the inert gas into the acid solution, even after the reducing gas, which is especially hydrogen gas, is bubbled into the acid solution. This is from the viewpoint of ensuring security and for the following reason: when the acid solution in which the reducing gas exists is mixed with the metal catalyst salt, by the reducing gas existing in the solution, the metal catalyst ions may be reduced, deposited and formed into particles by themselves before they reach the surface of the palladium-containing particles.

As the inert gas, there may be mentioned nitrogen gas, argon gas, etc. The inert gas bubbling time and the gas flow rate can be the same as the case of the reducing gas.

In the present invention, filtering, washing, drying, pulverizing, etc., of the carbon-supported catalyst can be carried out after the covering step.

The washing of the carbon-supported catalyst is not particularly limited, as long as it is a method that can remove impurities without any damage to the core-shell structure of the fine catalyst particles. An example of the washing is a method of carrying out suction filtration using water, perchloric acid, dilute sulfuric acid, dilute nitric acid, etc. Preferably, warm water is used for the washing of the carbon-supported catalyst.

The drying of the carbon-supported catalyst is not particularly limited, as long as it is a method that can remove the solvent, etc.

As needed, the carbon-supported catalyst can be pulverized. The pulverizing method is not particularly limited, as long as it is a method that can pulverize solids. Examples of the pulverization include pulverization using a mortar, etc., under an inert gas atmosphere or in the air, and mechanical milling using a ball mill, a turbo mill, etc.

A main characteristic of the present invention is that the amount of change in the potential with respect to the amount of the acid solution added drop by drop, which is obtained by the potentiometric titration method, is equal to or more than the specific value.

Hereinafter, the potentiometric titration method and subsequent analysis will be described in the following order: (1) preparation of a catalyst suspension used for titration, (2) measurement using the potentiometric titration method, and (3) titration curve analysis.

### (1) Preparation of Catalyst Suspension Used for Titration

First, a catalyst suspension is prepared by mixing the carbon-supported catalyst of the present invention with an alkali solution.

At this time, preferably, the BET specific surface area (m²/g) of the carbon-supported catalyst is measured in advance; the carbon-supported catalyst is weighed so that the total surface area (m²) becomes a predetermined value; and then the carbon-supported catalyst is used for titration. This is because, in the potentiometric titration method, the titration curve thus obtained varies depending on the total surface area of the sample used for the titration.

From the viewpoint of correctly evaluating the powder surface, the total surface area of the carbon-supported carrier used for titration is preferably 20 m² or more.

The alkali solution used for titration is preferably a mixed solution of an alkali aqueous solution and alcohol. This is for the following reason: in general, the material used as the carbon carrier takes on water repellency, so that the wettability of the carbon carrier can be increased by adding alcohol, which is an organic solvent.

The alkali aqueous solution in the alkali solution is not particularly limited, as long as it can ensure sufficiently high alkaline property. For example, there may be mentioned aqueous solutions of inorganic salts such as NaOH, KOH, LiOH and NaHCO₃, and ammonia water. These aqueous solutions can be used alone or in combination of two or more kinds.

In the potentiometric titration method in the present invention, in order to decrease the impedance of the aqueous solution, it is preferable to add a supporting electrolyte (supporting salt) to the alkali aqueous solution. Examples of the supporting electrolyte include KNO₃, NaNO₃, LiNO₃, KCl, NaCl and LiCl. These supporting electrolytes can be used alone or in combination of two or more kinds. In the case of measuring a porous powder, among these supporting electrolytes, one containing cations with an ionic radius that is equal to or less than the pores of the powder is generally used. Especially, like the potentiometric titration method in the present invention, in the case where a carbon having pores on the surface is included in the targets of titration, potassium ions with a relatively large ionic radius can be used. Also, the cations in the supporting electrolyte are preferably the same as the cations in the alkali aqueous solution. For example, when the cations in the alkali aqueous solution are potassium ions, potassium salt is preferably used as the supporting electrolyte. Of potassium salts, KNO₃ is preferred from the viewpoint of versatility.

The alcohol in the alkali solution is not particularly limited. For example, there may be mentioned methanol, ethanol, propanol and butanol. These alcohols can be used alone or in combination of two or more kinds. Of these alcohols, from the viewpoint of handling, ethanol is preferably used.

In the alkali solution, the mixed ratio (molar ratio) of the water and alcohol is preferably water:alcohol=5:1 to 2:1. When the water is less than the ratio, a titration curve which is sufficiently reliable from the viewpoint of reproducibility, may not be obtained. On the other hand, when the alcohol is less than the ratio, the alkali solution does not sufficiently penetrate the carbon-supported catalyst, so that accurate measurement results may not be obtained.

The mixed ratio (molar ratio) of the water and alcohol is more preferably water:alcohol=4.5:1 to 2.5:1, still more preferably water:alcohol=4:1 to 3:1.

The volume of the alkali solution used for titration is not particularly limited. For example, with respect to the carbon-supported catalyst having a total surface area of 20 m² or more, 80 to 120 mL of the alkali solution can be used.

At the time of carrying out the potentiometric titration method, the solution temperature of the alkali solution is preferably 15 to 30° C. When the solution temperature is out of the range, the pH of the alkali solution is varied, so that the reproducibility of the titration curve may decrease. It is preferable to appropriately control the solution temperature of the alkali solution using a thermostat bath or the like so that the solution temperature is not varied by neutralization heat, etc., which is generated during the titration.

It is preferable to set the initial pH of the alkali solution to 11.5 to 12.5 so that the pH is not largely varied in the early stage of the titration. By starting the titration using the alkali solution with a pH in the above range, a highly-reliable titration curve can be obtained from the early stage of the titration. The initial pH of the alkali solution can be controlled by the pH of the alkali aqueous solution, which is a raw material. For example, the pH of the alkali aqueous solution is preferably 11.5 to 12.5.

The method for mixing the carbon-supported catalyst with the alkali solution is not particularly limited. For example, there is a method in which the alkali solution is prepared in advance by mixing the alkali aqueous solution with alcohol, and then the alkali solution is mixed with the carbon-supported catalyst. There is another method in which the alkali aqueous solution and alcohol is added in sequence to the carbon-supported catalyst. There is another method in which the carbon-supported catalyst is sufficiently mixed with the alkali solution by adding the alkali solution to the carbon-supported catalyst in several batches.

To sufficiently disperse the carbon-supported catalyst in the alkali solution, they can be mixed and stirred with a homogenizer, stirrer, etc. As just described, to sufficiently ensure the wettability of the carbon-supported catalyst, it is preferable to carry out an appropriate mixing and dispersing treatment.

It is preferable to bubble an inert gas into the alkali solution. As just described, by substituting the atmosphere in the alkali solution in advance with an inert atmosphere, acidic components that are reactive with the alkali solution (e.g., carbon dioxide and oxygen) can be removed from the alkali solution, without such a failure that the amount of the acid solution added drop by drop differs from measurement to measurement; therefore, the reliability of titration results can be increased. It is preferable to bubble the inert gas into the alkali solution before the potentiometric titration method is conducted.

Examples of the inert gas include nitrogen gas and argon gas.

### (2) Measurement Using Potentiometric Titration Method

The titrator used in the potentiometric titration method can be a conventionally used titrator. Hereinafter, the titrator will be described by way of figures.

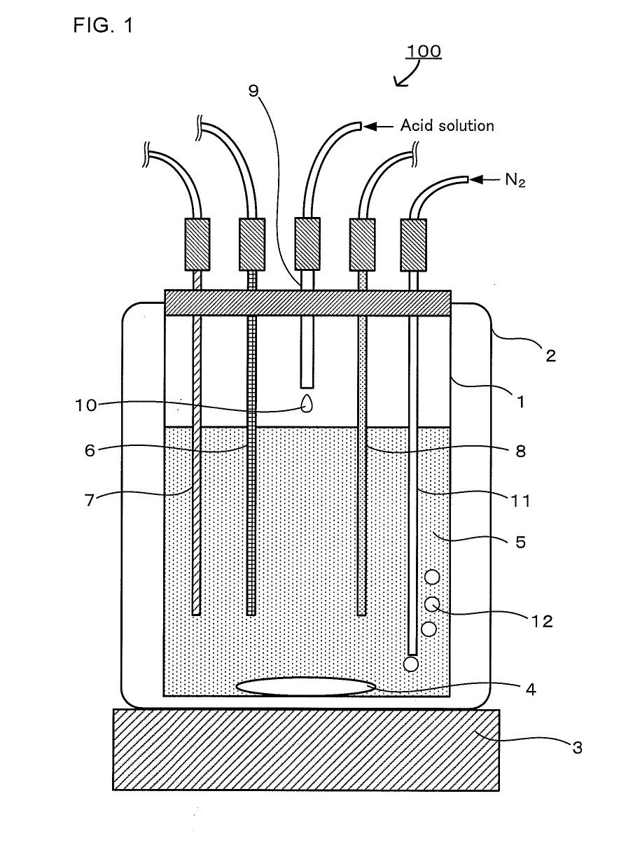

FIG. 1 is a schematic sectional view of a titrator 100. A double wavy line shown in FIG. 1 indicates that a part of the figure is omitted.

As shown in FIG. 1, a thermostat bath 2 housing a titration container 1 is placed on a stirrer 3. Inside the titration container 1, a stirrer bar 4 is installed and uniformly stirs a catalyst suspension 5 in the titration container 1.

Inside the titration container 1, a pH electrode 6 for measuring pH, a comparative electrode 7 and a temperature sensor 8 are installed so that they are fully immersed in the catalyst suspension 5. These electrodes and sensor are electrically connected to a control section, a recording terminal, etc., which are not shown in FIG. 1. As the comparative electrode 7, a silver-silver chloride electrode is generally used. Also inside the titration container 1, a burette 9 is installed so that one end thereof is positioned at a point that is appropriately distant from the surface of the catalyst suspension 5. A drop 10 in FIG. 1 indicates the acid solution added drop by drop. Also, a nitrogen gas line 11 is installed so that at least one end thereof is soaked in the catalyst suspension 5. From a nitrogen supply source (not shown) installed outside the thermostat bath 2, nitrogen is bubbled into the catalyst suspension 5 for a certain period of time saturate the catalyst suspension 5 with nitrogen. Circles 12 indicate nitrogen bubbles.

The acid solution used for the titration is not particularly limited, as long as it is an acid that can be generally used for acid-base titration. For example, there may be mentioned H₂SO₄, HCl, HNO₃, oxalic acid and acetic acid. These acid solutions can be used alone or in combination of two or more kinds. Of these acid solutions, from the viewpoint of handling, H₂SO₄ is preferably used.

For the titration amount, from the viewpoint of both titration time constraints and requests for obtaining an accurate titration curve, for example, it is preferable to add 0.01 to 0.2 mL drop by drop per 60 seconds, and it is more preferable to add 0.02 to 0.1 mL in drop by drop per 60 seconds.

### (3) Titration Curve Analysis

From the titration curve obtained by the potentiometric titration method, the amount of change in the potential (dV/d (mL/m²)) with respect to the amount of the acid solution added drop by drop in a predetermined potential range (V vs. Ag/AgCl) is calculated. As used herein, the amount of the acid solution added drop by drop (mL/m²) means the amount of the acid solution added drop by drop per unit surface area of the carbon-supported catalyst.

In the potentiometric titration method, potential can be substituted with pH. Accordingly, the amount of change in the potential (dV/d (mL/m²)) with respect to the amount of the acid solution added drop by drop, corresponds to a change in pH with respect to the amount of the acid solution added drop by drop. When the change is sufficiently large in the vicinity of a neutralization point, impurities and functional groups which are likely to cause an acid-base reaction with the acid solution do not exist on the surface of the carbon-supported catalyst, so that it can be evaluated that the transition of the liquid property of the catalyst suspension from alkaline property to acidic property becomes rapid. On the other hand, when the change is small in the vicinity of the neutralization point, it is presumed that an acid-base reaction has occurred between the acid solution added drop by drop and the impurities and functional groups on the surface of the carbon-supported catalyst. As the result, it can be evaluated that the transition of the liquid property of the catalyst suspension from alkaline property to acidic property becomes slow.

As just described, by evaluating the amount of change in the potential with respect to the amount of the acid solution added drop by drop in a specific potential range, the condition of the surface of the carbon-supported catalyst can be quantitatively determined.

In the present invention, the potential range corresponding to the neutralization point is set to a range of 0.095 to 0.105 V (vs. Ag/AgCl).

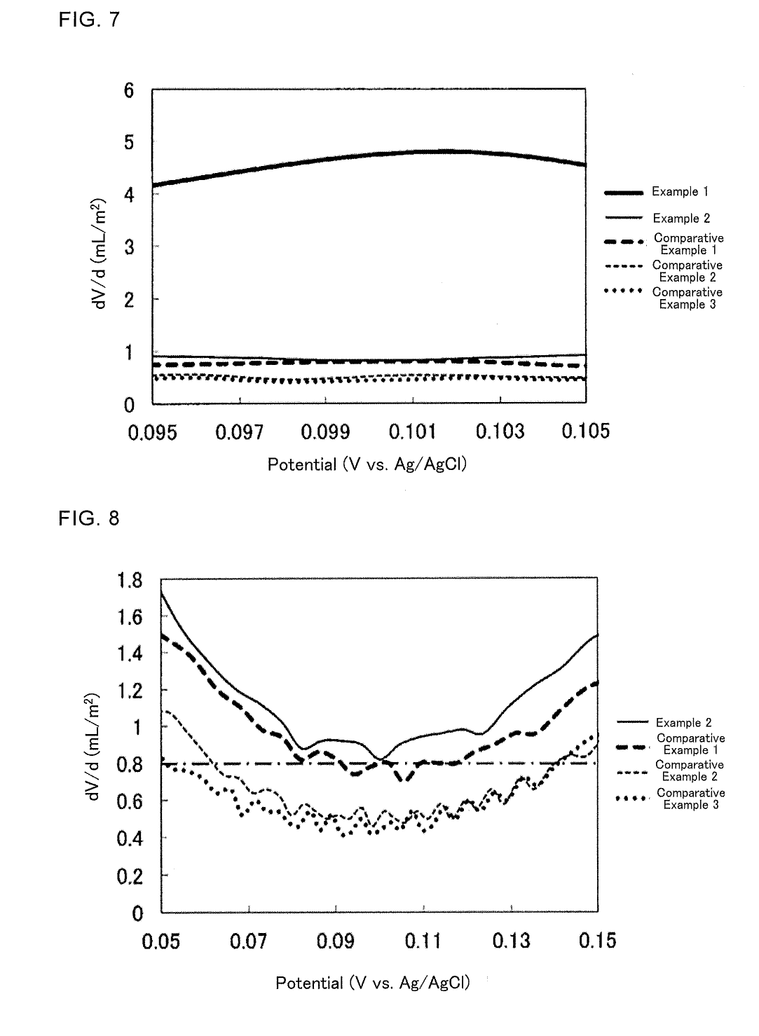

As will be shown in the below-described Examples and FIGS. 7 and 10, in the potential range, such a carbon-supported catalyst that the amount of change in the potential with respect to the amount of the acid solution added drop by drop is always 0.8 (dV/d (mL/m²)) or more (Examples 1 and 2) is higher in both cell voltage and mass activity, compared to such a carbon-supported catalyst that the amount of change in the potential is less than 0.8 (dV/d (mL/m²)) (Comparative Examples 1 to 3). Therefore, for the carbon-supported catalyst in which the amount of change in the potential with respect to the amount of the acid solution added drop by drop, is always 0.8 (dV/d (mL/m²)) or more, it is considered that impurities and excessive functional groups are less on the surface, so that it has high affinity for other fuel cell materials such as electrolyte. Therefore, it can be determined that such a carbon-supported catalyst can be preferably used as an electrode catalyst for fuel cells.

The potential range where the amount of change in the potential with respect to the amount of the acid solution added drop by drop, is 0.8 (dV/d (mL/m²)) or more, is preferably a range of 0.080 to 0.120 V (vs. Ag/AgCl), more preferably a range of 0.050 to 0.150 V (vs. Ag/AgCl).

Actually, it is not clear what acid-base reaction proceeds in the catalyst suspension, in a range of 0.095 to 0.105 V (vs. Ag/AgCl). However, as will be described below under “Examples”, such a carbon-supported catalyst that the number of potential cycles conducted in advance on the palladium-supported carbon, which is be a raw material, is large (Example 2) shows a larger potential change amount in the above potential range, compared to such a carbon-supported catalyst that the number of the potential cycles is small (Comparative Examples 2 and 3). Therefore, it is presumed that an acid-base reaction proceeds between the acid solution and the functional groups and/or impurities on the carbon carrier surface.

For the functional groups and impurities on the carbon carrier surface, only a qualitative finding on whether or not the functional groups, etc., are present on the carbon carrier surface, has been obtained. However, by the potentiometric titration method of the present invention, these functional groups, etc., can be quantitated and, as the result, a carbon-supported catalyst with excellent activity can be selected.

In the titration curve, the amount of change in the potential with respect to the amount of the acid solution added drop by drop in a range where the potential is −0.020 to 0.020 V (vs. Ag/AgCl) is preferably 2 (dV/d (mL/m²)) or more.

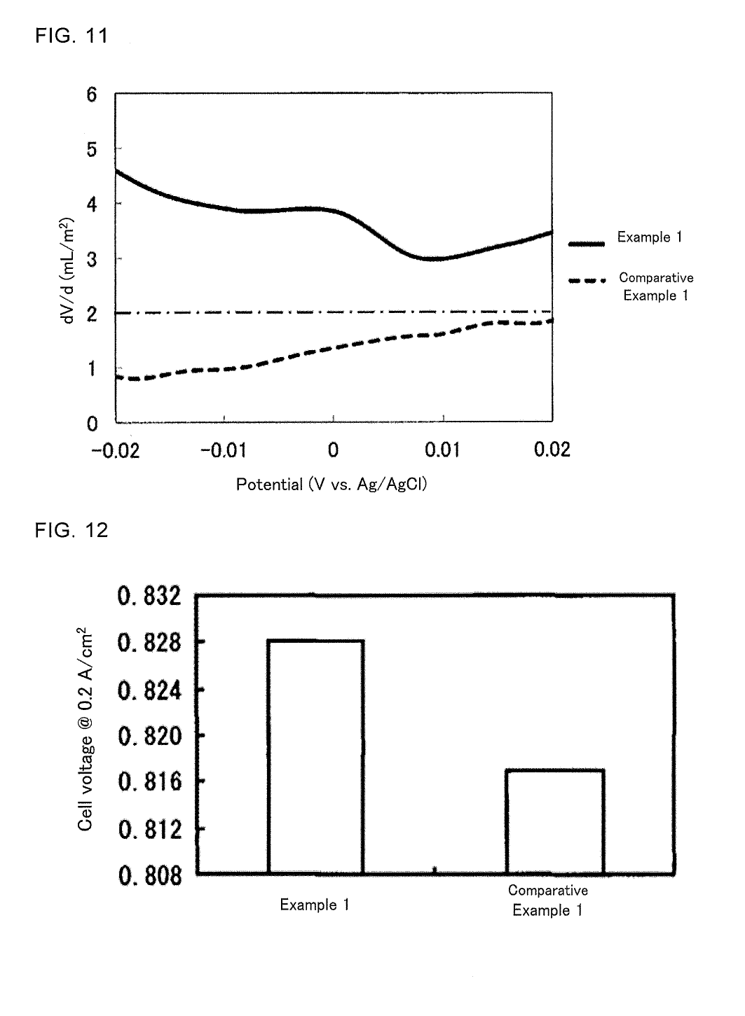

As will be shown under “Examples” below, Comparative Example 1 is the same as Example 1, except that the amount of platinum used was changed to 90% of the amount in Example 1. When the minimum platinum atom amount which is required to cover the palladium particles with a platinum monatomic layer is 100 atm %, in Example 1, the coverage of the palladium particles with platinum is kept high by the use of 100 atm % platinum. As the result, in the above potential range, the amount of change in the potential with respect to the amount of the acid solution added drop by drop, exceeds 2 (dV/d (mL/m2)). Meanwhile, in Comparative Example 1, the coverage of the palladium particles with platinum is reduced by decreasing the used platinum amount lower than Example 1. As the result, in the above potential range, the amount of change in the potential with respect to the amount of the acid solution added drop by drop, is less than 2 (dV/d (mL/m²)) (see FIG. 11).

In the above potential range, the amount of change in the potential with respect to the amount of the acid solution added drop by drop, is preferably 2.5 (dV/d (mL/m²)) or more.

As is clear by reference to the below-described PdO(II)·xH₂O graph (plotted with x) in FIG. 4, it is considered that in a potential range of −0.020 to 0.020 V (vs. Ag/AgCl), a reaction between the acid solution and palladium oxide exposed on the fine catalyst particle surface has occurred in the catalyst suspension.

Therefore, it is clear that not only the carbon carrier surface in the carbon-supported catalyst, but also the coverage of the palladium particles on the fine catalyst particle surface with the platinum-containing outermost layer, can be calculated by examining the amount of change in the potential with respect to the amount of the acid solution added drop by drop in a potential range of −0.020 to 0.020 V (vs. Ag/AgCl), together with examining that in the above potential range of 0.095 to 0.105 V (vs. Ag/AgCl).

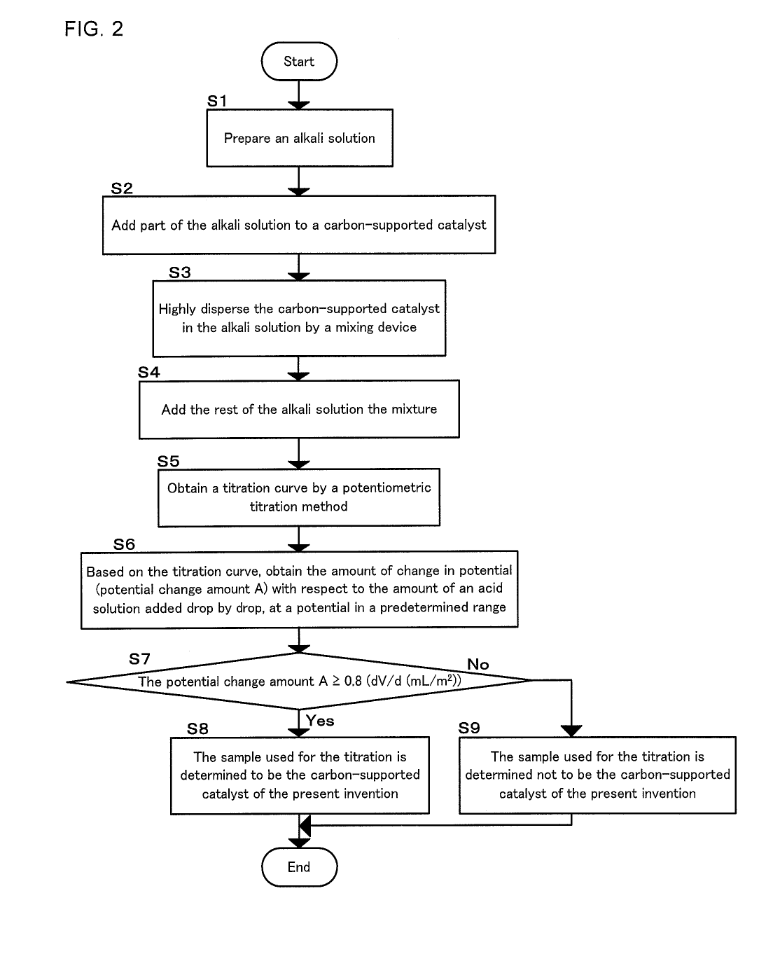

Hereinafter, a typical example of the flow of a series of the above-described (1) to (3) will be described. FIG. 2 is a flow chart of a typical example of the process starting from the preparation of a catalyst suspension to the analysis of a titration curve in the present invention. Hereinafter, the present invention will be described according to the flow in FIG. 2.

First, an alkali solution is prepared by mixing an alkali aqueous solution and alcohol (S1). As the alkali aqueous solution, a mixture of 0.1 M KNO3 aqueous solution and 0.5 M KOH aqueous solution is used, which has a pH of 12. As the alcohol, 99.5% ethanol is used. At this time, the amounts of the alkali aqueous solution and alcohol are adjusted so that the molar ratio after the mixing is in a range of water:alcohol=4:1, and the total volume of the alkali solution after the mixing is 100 mL.

Next, part of the alkali solution is added to a carbon-supported catalyst (S2). For the carbon-supported catalyst, the BET specific surface area is measured in advance, and the carbon-supported catalyst was weighted so that the total surface area becomes 20 m². Then, the carbon-supported catalyst is mixed with the part of the alkali solution. As used herein, “part of the alkali solution” is not particularly limited, as long as it is an amount that can entirely wet the carbon-supported catalyst. For example, it can be half the amount scheduled to use.

Then, the carbon-supported catalyst is highly dispersed in the alkali solution by a mixing device such as homogenizer or stirrer (S3). After the carbon-supported catalyst is sufficiently mixed with the alkali solution, the rest of the alkali solution is added to the mixture (S4). The solution temperature of the catalyst suspension is controlled so as to be 25° C. after the mixing, and as an inert gas, nitrogen is bubbled into the mixture for 30 minutes. Then, the resultant is used for potentiometric titration.

Next, an acid solution is added drop by drop to the catalyst suspension prepared, and a titration curve is obtained by the potentiometric titration method (S5). In particular, first, titration is initiated using the device shown in FIG. 1, with bubbling nitrogen into the catalyst suspension 5. For the titration, 0.05 M sulfuric acid is used, and the titration rate is set to 0.05 mL per 60 seconds. During the titration, the solution temperature of the catalyst suspension 5 is kept at 25° C. by the thermostat bath 2.

Based on the thus-obtained titration curve, the amount A of change in the potential (potential change amount A) with respect to the amount of the acid solution added drop by drop at a potential in a predetermined range, is obtained (S6). At this time, as the amount of the acid solution added drop by drop, a value (unit: mL/m²) obtained by dividing the actual amount of the acid solution added drop by drop by the BET specific surface area of the carbon-supported catalyst is used. Therefore, the unit of the potential change amount A is dV/d (mL/m²).

Finally, it is determined whether or not the potential change amount A is 0.8 (dV/d (mL/m²)) or more at a potential in a predetermined range (S7). The predetermined range of the potential is generally 0.095 to 0.105 V (vs. Ag/AgCl), preferably 0.080 to 0.120 V (vs. Ag/AgCl), more preferably 0.050 to 0.150 V (vs. Ag/AgCl) . When the potential change amount A is always 0.8 (dV/d (mL/m²)) or more in the predetermined range of the potential, the sample used for the titration is determined to be the carbon-supported catalyst of the present invention, and the flow is ended (S8). On the other hand, when there is a part where the potential change amount A is less than 0.8 (dV/d (mL/m²)) in the predetermined range of the potential, the sample used for the titration is determined not to be the carbon-supported catalyst of the present invention, and the flow is ended (S9).

The amount B of change in the potential (potential change amount B) with respect to the amount of the acid solution added drop by drop in the range where the potential is −0.020 to 0.020 V (vs. Ag/AgCl) is determined as follows. First, the potential change amount B is obtained by carrying out S1 to S6 of the flow chart shown in FIG. 2. Then, it is determined whether or not the potential change amount B is 2 (dV/d (mL/m²)) or more. When the potential change amount B is always 2 (dV/d (mL/m²)) or more in the above potential range, the sample used for the titration is determined to be the preferred carbon-supported catalyst of the present invention, and the flow is ended. On the other hand, when there is a part where the potential change amount B is less than 2 (dV/d (mL/m²)) in the above potential range, the sample used for the titration is determined not to be the preferred carbon-supported catalyst of the present invention, and the flow is ended.

### EXAMPLES

Hereinafter, the present invention will be described in more detail, by way of examples and comparative examples. The present invention is not limited to these examples.

### 1. Production of Carbon-Supported Catalyst

### Example 1

### 1-1. Production of Carbon-Supported Palladium

OSAB (product name, manufactured by: Denki Kagaku Kogyo Kabushiki Kaisha) was used as a carbon carrier. The carbon carrier was dispersed in nitric acid. Chloropalladous acid was added to the dispersion mixture. With heating the mixture under a temperature condition of 100° C. or less, sodium boron hydride (NaBH₄) was added to the mixture to reduce palladium. After the reaction was completed, the reaction mixture was filtered, and a product thus obtained was dried under an inert atmosphere for 24 hours, thereby producing carbon-supported palladium. In the thus-obtained carbon-supported palladium, the average particle diameter of the palladium particles was 3.4 nm.

Then, 5 g of the thus-produced carbon-supported palladium was added to 1L of pure water and dispersed therein using an ultrasonic homogenizer. A dispersion thus obtained was put in an electrochemical reactor. Sulfuric acid was added thereto so that the sulfuric acid concentration in the dispersion became 0.05 mol/L. The electrochemical reactor was moved to the inside of a glove box. An inert gas (N₂ gas) was sufficiently bubbled into the dispersion to deaerate oxygen. Then, 1,600 cycles of a potential range of 0.05 to 1.2 V (vs. RHE) were carried out on the working electrode of the electrochemical reactor, thereby sufficiently cleaning the palladium particle surface and the carbon carrier surface.

### 1-2. Deposition Step (Cu-UPD)

A copper ion-containing acid solution of 14.6 g of copper sulfate pentahydrate dissolved in 66 mL of 0.05 M sulfuric acid was added to sulfuric acid, with bubbling nitrogen into the sulfuric acid. The potential of the working electrode was fixed at 0.4 V (vs. RHE) for 2 hours, thereby depositing copper on the palladium particles.

1-3. Substitution step

The potential control at 0.4 V (vs. RHE) was stopped. A platinum ion-containing acid solution of 161.3 mg of K₂PtCl₄ and 4.5 g of citric acid monohydrate dissolved in 140 mL of 0.05 M sulfuric acid, was added to the mixture containing the carbon-supported palladium for about 80 minutes. Then, the mixture was stirred for one hour, thereby substituting copper with platinum. The amount of platinum atoms added at this point was 100 atm %, when the minimum amount of platinum atoms required to cover each palladium particle with a platinum monatomic layer was determined as 100 atm %.

### 1-4. Post-Treatment

The reaction solution was filtered to collect the carbon-supported catalyst. The carbon-supported catalyst was washed, dried and then pulverized using an agate mortar and a pestle, thereby producing the carbon-supported catalyst of Example 1.

### Example 2

The carbon-supported catalyst of Example 2 was produced in the same manner as Example 1, except that carbon-supported palladium in which the average particle diameter of the palladium particles is 3.8 nm was produced and used.

### Comparative Example 1

The carbon-supported catalyst of Comparative Example 1 was produced in the same manner as Example 1, except that in the substitution step, the amount of platinum atoms added was set to 90 atm %, when the minimum amount of platinum atoms required to cover each palladium particle with a platinum monatomic layer was determined as 100 atm %.

### Comparative Example 2

The carbon-supported catalyst of Comparative Example 2 was produced in the same manner as Example 1, except that carbon-supported palladium in which the average particle diameter of the palladium particles is 3.8 nm was produced and used, and at the time of cleaning of the palladium surface and the carbon surface in the carbon-supported palladium raw materials, the cleaning condition was changed to 800 cycles of a potential range of 0.05 to 1.2 V (vs. RHE).

### Comparative Example 3

The carbon-supported catalyst of Comparative Example 3 was produced in the same manner as Example 1, except that carbon-supported palladium in which the average particle diameter of the palladium particles is 3.8 nm was produced and used, and the cleaning of the palladium surface and the carbon surface in the carbon-supported palladium raw materials was not carried out.

### 2. Evaluation of Carbon-Supported Catalyst

### 2-1. Measurement of BET Specific Surface Area

For the carbon-supported catalysts of Examples 1 and 2 and Comparative Examples 1 to 3, the BET specific surface area was measured.

First, for each carbon-supported catalyst, the supported metal ratio x (mass %) was measured by ICP-MS. Next, for each carbon-supported catalyst, the BET specific surface area was measured by an automatic specific surface area/pore distribution measuring device (product name: Tristar 3020, manufactured by: Micromeritics). The BET specific surface area thus measured was determined as S₀ (m²/g-catalyst). From the BET specific surface area S₀ and the supported metal ratio x, the BET specific surface area of the carbon carrier in the carbon-supported catalyst, that is, the BET specific surface area S (m²/g-carbon) was calculated by the following formula (A):

S=S₀×{(100−x)/100} Formula (A)

### 2-2. Catalyst Evaluation by Potentiometric Titration

Potentiometric titration was carried out on the carbon-supported catalysts of Examples 1 and 2 and Comparative Examples 1 to 3.

First, 0.1 M KNO₃ aqueous solution was prepared and controlled to have a pH of 12 by 0.5 M KOH aqueous solution. The resultant was used as an alkali aqueous solution.

Using the alkali aqueous solution and 99.5% ethanol, 100 mL of an alkali solution was prepared by mixing the alkali aqueous solution and the ethanol so that the molar ratio of water and ethanol became as follows: water:ethanol=4:1. Nitrogen gas was always bubbled into the alkali solution so that the pH was not increased by the incorporation of acidic gas such as carbon dioxide.

Concurrently with the preparation of the alkali solution, based on the result of the above BET specific surface area measurement, the carbon-supported catalyst was weighed in a measurement container so that the total surface area of the carbon-supported catalyst became 20 m². Then, 50 mL of the alkali solution was added to the weighed carbon-supported catalyst, thereby preparing a catalyst suspension.

With bubbling nitrogen gas, the thus-obtained catalyst suspension was dispersed by a homogenizer (continuous ultrasonic generator GSCVP-600, manufactured by Ginsen Co., Ltd., power output 50%, maximum power output 600 W). The dispersion conditions by the homogenizer are as follows: the dispersion time (on time) was set to 60 seconds; the outage time (off time) was set to 60 seconds; and the dispersion time and the outage time were carried out two times each, alternately. Accordingly, the total of the on time is 120 seconds.

After the dispersion treatment by the homogenizer, to sufficiently mix the solvent and the carbon-supported catalyst, the catalyst suspension was stirred for 12 hours using a stirrer, with bubbling nitrogen gas thereinto.

After the stirring, the catalyst suspension was further mixed with 50 mL of the alkali solution, so that the total volume became 100 mL. The catalyst suspension was moved to a thermostat bath set at 25° C. Then, the catalyst suspension was left until the temperature reached 25° C., with continuously stirring the catalyst suspension and bubbling nitrogen gas thereinto.

Using the titrator shown in FIG. 1, potentiometric titration was carried out by adding the acid solution drop by drop to the catalyst suspension, with bubbling nitrogen into the catalyst suspension, thereby obtaining a titration curve. Detailed titration conditions are shown below.
Catalyst suspension: sample carbon-supported catalyst and 100 mL mixed solution of 0.1 M KNO₃ aqueous solution and ethanol (in advance, nitrogen was bubbled into the mixed solution for 30 minutes)
Atmosphere of catalyst suspension: Under nitrogen atmosphere
Solution temperature of catalyst suspension: 25° C.
Comparative electrode: Silver-silver chloride electrode
Acid solution: 0.05 M H₂SO₄ aqueous solution
Titration rate: 0.05 mL per 60 seconds

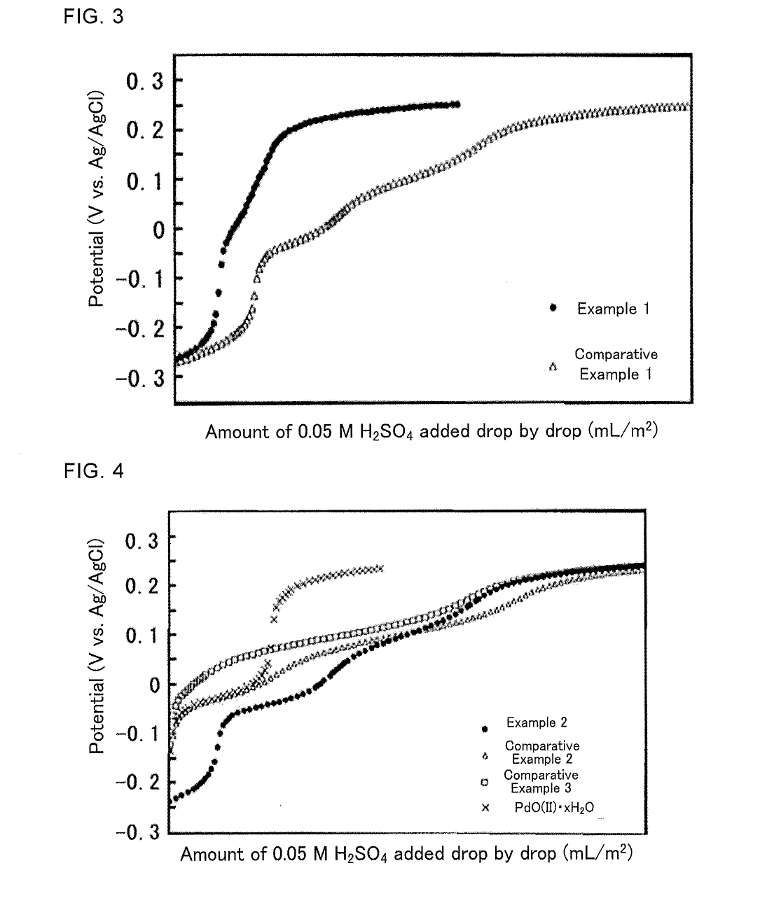

FIG. 3 is a graph of the potentiometric titration curves of Example 1 and Comparative Example 1. FIG. 4 is a graph of the potentiometric titration curves of Example 2 and Comparative Examples 2 and 3. FIGS. 3 and 4 are graphs with potential (V vs. Ag/AgCl) on the vertical axis and the amount of the sulfuric acid added drop by drop (mL/m²) on the horizontal axis. The amount of the sulfuric acid added drop by drop on the horizontal axis is a value converted to the amount of the sulfuric acid added drop by drop (mL/m²) per unit surface area of the carbon-supported catalyst.

The potential on the horizontal axis in FIGS. 3 and 4 indicate the liquid property of the catalyst suspension. That is, 0 V (vs. Ag/AgCl) corresponds to a pH of 7, and as the potential increases by 0.06 V from 0 V, the pH decreases by about 1 (that is, the solution property becomes acidic property). In contrast, as the potential decreases by 0.06 V from 0 V, the pH increases by about 1 (that is, the liquid property becomes alkaline property). Since the solvent used in the catalyst suspensions of Examples 1 and 2 and Comparative Examples 1 to 3 is a mixed solvent containing ethanol, etc., it is difficult to accurately calculate the pH. This is because a standard pH buffer solution of the mixed solvent is not commercially available. Accordingly, in Examples 1 and 2 and Comparative Examples 1 to 3, it is shown as a relative value that is a potential with respect to the comparative electrode (reference electrode).

For the horizontal axis (the amount of the sulfuric acid added drop by drop on the horizontal axis) in FIGS. 3 and 4, the left end of the horizontal axis indicates that the amount of the sulfuric acid added drop by drop is 0, and the amount increases toward the right.

As is clear from FIG. 3, in the graph of Example 1 (plotted with black circle), a so-called pH jump (a rapid pH change from alkaline to acidic) is caused by the relatively small amount of the sulfuric acid added drop by drop. Meanwhile, in the graph of Comparative Example 1 (plotted with white triangle), the potential change is small around −0.05 to 0.05 V (vs. Ag/AgCl) and 0.05 V to 0.15 V (vs. Ag/AgCl), so that the graph is flat. In Comparative Example 1, therefore, the amount of the sulfuric acid added drop by drop and consumed until the end of the potentiometric titration, is larger than Example 1.

From the above, for the carbon-supported catalyst of Example 1, it is presumed that the change in the solution property of the catalyst suspension from alkaline property to acidic property occurs rapidly, since there is almost no factor on the catalyst surface, which contributes to an acid-base reaction with the sulfuric acid. Meanwhile, for the carbon-supported catalyst of Comparative Example 1, there is some sort of factor on the catalyst surface, which contributes to an acid-base reaction with the sulfuric acid; therefore, it is clear that compared to Example 1, a larger amount of the sulfuric acid is used for the titration until the catalyst suspension becomes acidic. In the graph of Comparative Example 1, flat parts appear at two points around −0.05 to 0.05 V (vs. Ag/AgCl) and 0.05 V to 0.15 V (vs. Ag/AgCl); therefore, it is presumed that the carbon-supported catalyst of Comparative Example 1 has at least two factors that are reactive with the sulfuric acid.

As is clear from FIG. 4, in the graph of Example 2 (plotted with black circle), the graph of Comparative Example 2 (plotted with white triangle) and the graph of Comparative Example 3 (plotted with white square), as with Comparative Example 1, flat parts appear around −0.05 to 0.05 V (vs. Ag/AgCl) and 0.05 V to 0.15 V (vs. Ag/AgCl). However, as the result of focusing on the flat part around 0.05 V to 0.15 V (vs. Ag/AgCl), it is clear that the length of the flat part gets shorter in the order of Example 2, Comparative Example 2 and Comparative Example 3. This fact means that compared to Comparative Example 2 in which the number of the potential cycles is small and Comparative Example 3 in which the cleaning of the palladium surface, etc., was not carried out, the amount of the sulfuric acid added drop by drop and consumed at the flat part is smaller in Example 2 in which the number of the potential cycles carried out is larger. Only from FIG. 4, it is not possible to specify what acid-base reaction occurred in the flat part. However, because (1) the flat part is shortened by increasing the number of the potential cycles carried out on the palladium particle surface and (2) the BET specific surface area of the carbon-supported catalyst gets larger in the order of Comparative Example 3, Comparative Example 2 and Example 2, it is presumed that the flat part is derived and caused from the impurities on the catalyst surface.

Impurities attach onto the carbon surface under various kinds of conditions, such as the step of supporting palladium particles or storage in the air. Once impurities exist on the carbon surface, it is considered that carbon is likely to aggregate at the time of core-shell synthesis, due to an interaction between the impurities on the carbon; moreover, in Cu-UPD, uniform potential is not applied at the time of covering with copper, and the covering of the palladium particles with copper does not smoothly proceed. When the progress of the covering reaction of the palladium particles with copper is hindered, the subsequent substitution reaction of copper with platinum is also hindered. Also, when impurities exist on the carbon surface, there is a possibility that copper and/or platinum is deposited on the impurities, and it is considered that the palladium particles are not sufficiently covered with a platinum outermost layer.

Moreover, in the PdO(II)·.xH₂O graph (plotted with x) shown in FIG. 4, a flat part appears only around −0.05 to 0.05 V (vs. Ag/AgCl). Therefore, it is presumed that the flat part around −0.05 to 0.05 V (vs. Ag/AgCl) shown in the graph of Comparative Example 1, etc., is derived from a reaction between the palladium oxide and the sulfuric acid. That is, when the palladium particles (core) are exposed in the synthesized carbon-supported catalyst, it is considered that the palladium oxide is contained in the exposed parts. As the result, in the potentiometric titration curve, the existence of the palladium oxide is indicated in the form of the flat part around −0.05 to 0.05 V (vs. Ag/AgCl). Therefore, it is considered that the amount of the exposed palladium oxide can be obtained from the amount of the sulfuric acid added drop by drop and consumed at the flat part, and the coverage of each palladium particle with the platinum outermost layer can be also evaluated.

As is clear from FIG. 3, the carbon-supported catalyst of Example 1 does not have any flat part around −0.05 to 0.05 V (vs. Ag/AgCl). Therefore, for the carbon-supported catalyst of Example 1, it is predicted that since the coverage of each palladium particle with the platinum outermost layer is high, the palladium particles are not exposed on the catalyst surface, and less impurities and functional groups exist on the catalyst surface.

As described above, in the data of Example 1, any flat part does not exist around 0.05 V to 0.15 V (vs. Ag/AgCl), and the flat part around −0.05 to 0.05 V (vs. Ag/AgCl) is very short. Therefore, it is predicted that there is almost no impurities, functional groups, etc., on the surface of the carbon-supported catalyst of Example 1, which are able to cause an acid-base reaction.

In the data of Example 2, the flat part around 0.05 V to 0.15 V (vs. Ag/AgCl) is shorter than the data of Comparative Examples 2 and 3. Therefore, it is predicted that there are less impurities, functional groups, etc., on the surface of the carbon-supported catalyst of Example 2, which are able to cause an acid-base reaction.

The above consideration is a qualitative consideration based on the potentiometric titration curve data. Hereinafter, the properties of the carbon-supported catalysts will be qualitatively discussed, with reference to the values of the amount of change in the potential with respect to the amount of the acid solution added drop by drop.

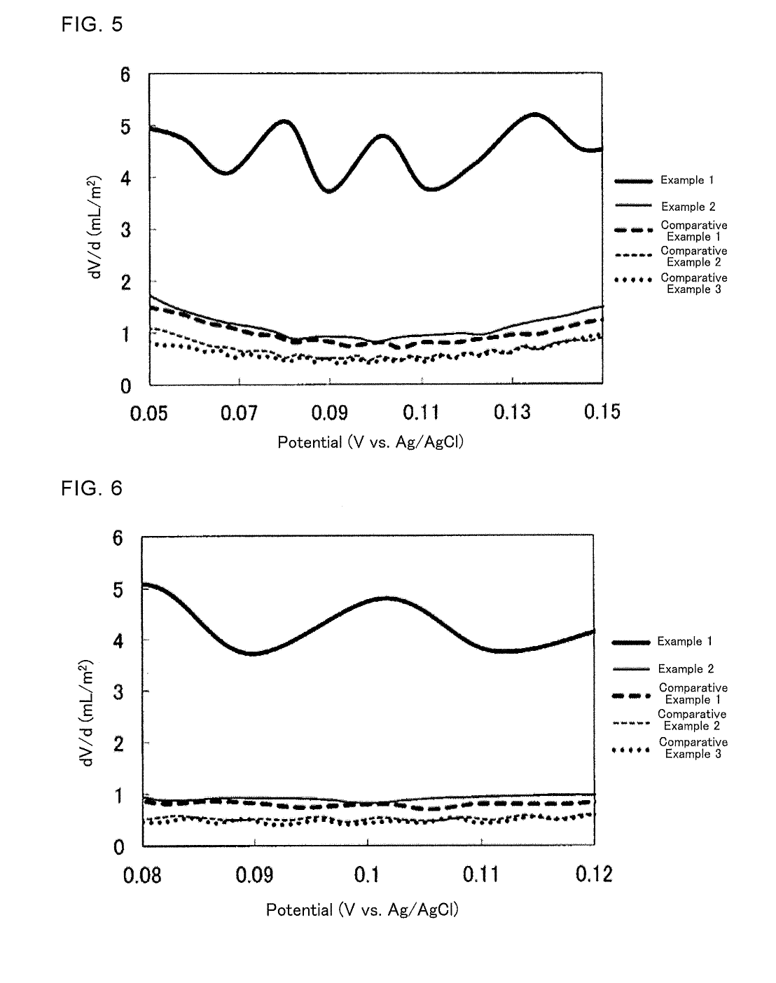

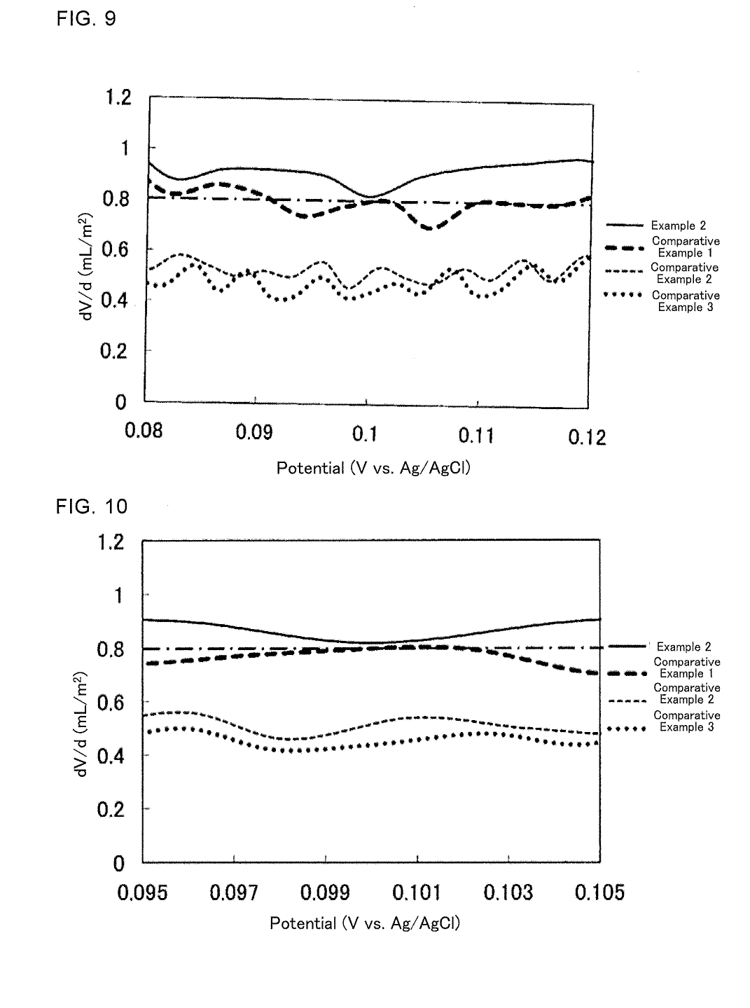

FIGS. 5 to 7 are graphs of the amount of change in the potential with respect to the amount of the acid solution added drop by drop, for the carbon-supported catalysts of Examples 1 and 2 and Comparative Examples 1 to 3. They are graphs with the amount of change in the potential (dV/d (mL/m²)) with respect to the amount of the acid solution added drop by drop on the vertical axis and potential (V vs. Ag/AgCl) on the horizontal axis. In FIG. 5, the range of the horizontal axis is 0.050 to 0.150 V (vs. Ag/AgCl). In FIG. 6, the range of the horizontal axis is 0.080 to 0.120 V (vs. Ag/AgCl). In FIG. 7, the range of the horizontal axis is 0.095 to 0.105 V (vs. Ag/AgCl). That is, FIG. 6 is the graph of FIG. 5 which is enlarged in the horizontal axis direction, and FIG. 7 is the graph of FIG. 6 which is further enlarged in the horizontal axis direction. FIGS. 8 to 10 are the graphs of FIGS. 5 to 7 which are further enlarged in the vertical axis direction, for ease of description. The alternate long and short dash line shown in the graphs of FIGS. 8 to 10 indicates a line on which the value of the amount of change in the potential with respect to the amount of the acid solution added drop by drop is 0.8 (dV/d (mL/m²)).

As is clear from FIGS. 5 to 7, in the graph of Example 1, the value of the amount of change in the potential with respect to the amount of the acid solution added drop by drop exceeds 3 (dV/d (mL/m²)) in the whole range of 0.050 to 0.150 V (vs. Ag/AgCl). Therefore, for the carbon-supported catalyst of Example 1, it can be evaluated that in the whole potential range, the amount of change in the potential with respect to the amount of the acid solution added drop by drop is large, and the pH jump from alkaline to acidic is sufficiently large.

As is clear from FIGS. 8 to 10 enlarged in the vertical axis direction, in the graph of Example 2, the value of the amount of change in the potential with respect to the amount of the acid solution added drop by drop exceeds 0.8 (dV/d (mL/m²)) in the whole range of 0.050 to 0.150 V (vs. Ag/AgCl) (see the alternate long and short dash line in the graph). Therefore, for the carbon-supported catalyst of Example 2, it can be evaluated that the amount of change in the potential with respect to the amount of the acid solution added drop by drop is large in the whole potential range, and the liquid property rapidly transfers from alkaline property to acidic property.

FIG. 11 is a graph of the amount of change in the potential with respect to the amount of the acid solution added drop by drop, for the carbon-supported catalysts of Example 1 and Comparative Example 1. The vertical and horizontal axes in FIG. 11 is the same as FIGS. 5 to 10, except that the range of the horizontal axis is −0.02 to 0.02 V (vs. Ag/AgCl). The alternate long and short dash line in FIG. 11 indicates a line on which the value of the amount of change in the potential with respect to the amount of the acid solution added drop by drop is 2 (dV/d (mL/m²)).

As is clear from FIG. 11, in the graph of Example 1, the value of the amount of change in the potential with respect to the amount of the acid solution added drop by drop exceeds 2 (dV/d (mL/m²)) in the whole range of −0.02 to 0.02 V (vs. Ag/AgCl). Therefore, for the carbon-supported catalyst of Example 1, it can be evaluated that even in the whole potential range, the pH jump from alkaline to acidic is sufficiently large.

### 2-3. Measurement of Catalytic Activity

### (1) MEA Evaluation

A membrane electrode assembly (MEA) was produced using each of the carbon-supported catalysts of Example 1 and Comparative Example 1. The catalytic activity of each catalyst was evaluated by measuring the cell voltage of each MEA.

### (a) Production of MEA

First, 0.9 g of each carbon-supported catalyst and 14.24 g of water were mixed by centrifugal stirring to sufficiently mix the carbon-supported catalyst and water. Next, 8.16 g of ethanol was added to the mixture, and the mixture was uniformly mixed also by centrifugal stirring. In addition, 1.9 g of an electrolyte (product name: DE2020CS, manufactured by: DuPont) was added to the mixture, and the mixture was uniformly mixed also by centrifugal stirring, thereby obtaining a catalyst ink raw material.

Under a dry atmosphere, 20 mL of the catalyst ink raw material and 60 g of PTFE grinding balls (diameter 2.4 mm) were put in a PTFE pot. The pot was hermetically closed, installed in a planetary ball mill, and subjected to mechanical milling under the conditions of a plate rotational frequency of 600 rpm, a temperature of 20° C., and a treatment time of one hour. After the mechanical milling was completed, the mixture in the container was filtered with a mesh to remove the balls from the mixture, thereby obtaining a catalyst ink.

The catalyst ink was filled into a spray gun (product name: SpectrumS-920N, manufactured by: Nordson) and applied to one side (cathode side) of an electrolyte membrane (product name: NR211, manufactured by: DuPont) in a catalyst amount of 300 to 500 μg/cm². An ink was produced in the same manner as the cathode side and applied to the other side (anode side) of the electrolyte membrane, except that a commercially-available platinum-supported carbon (manufactured by Tanaka Kikinzoku Kogyo K. K.) was used and the platinum amount per electrode area was set to 0.1 mg. A membrane electrode assembly having an area of 13 cm² was obtained in this manner.

Hereinafter, for ease of description, the membrane electrode assembly using the carbon-supported catalyst of Example 1 or Comparative Example 1 as a raw material may be referred to as membrane electrode assembly of Example 1 or membrane electrode assembly of Comparative Example 1.

### (b) IV Evaluation Using MEA

IV evaluation was carried out on the membrane electrode assemblies of Example 1 and Comparative Example 1 in the following conditions, and the cell voltage was measured.
Current density: 0.2 A/cm²
Fuel gas: Hydrogen gas (hydrogen stoichiometry 1.2)
Oxidant gas: Air (air stoichiometry 1.4)
Temperature: 60° C.
Humidity: Anode/cathode dew point 55° C.

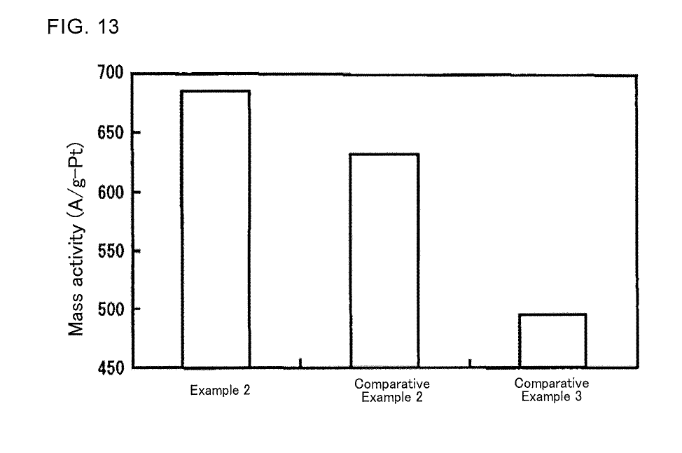

FIG. 12 is a bar graph comparing the cell voltages of the membrane electrode assemblies of Example 1 and Comparative Example 1.

According to FIG. 12, while the cell voltage of the membrane electrode assembly of Comparative Example 1 is 0.816 V, the cell voltage of the membrane electrode assembly of Example 1 is 0.828 V.

The fact that the voltage of Example 1 is 0.012 V higher than Comparative Example 1 under the condition of a current density of 0.2 A/cm², is very important from a practical viewpoint. Assume that, for example, 400 cells having an area of 300 cm² each, are used in a stack of fuel cells for vehicles. In this case, the fact that the voltage of each fuel cell is 0.012 V higher than conventional fuel cells, results in that a difference in power output of (0.2 A/cm²×300 cm²×0.012 V×400 cells=) 288 W occurs in the stack of the fuel cells. Therefore, a difference of 0.012 V in each fuel cell results in an extremely large power output difference in the stack of the fuel cells. When a difference of 0.012 V occurs in a low current range of 0.2 A/cm², a larger voltage difference occurs in the stack of the fuel cells, in a current range higher than 0.2 A/cm².

### (2) RDE Evaluation

For the carbon-supported catalysts of Example 2 and Comparative Examples 2 and 3, the mass activity was obtained using a rotating disk electrode (hereinafter may be referred to as RDE).

### (a) Preparation of RDE

The carbon-supported catalyst was dried to obtain a powder. The powder was pulverized with a mortar. This powder was dispersed in a mixed solution of 6.0 mL of ultrapure water, 1.5 mL of isopropanol, and 35 μL of 5% perfluorocarbon sulfonic acid polymer-based electrolyte (Nafion (trademark) manufactured by DuPont) dispersion. The thus-obtained dispersion was applied to the RDE and naturally dried.

### (b) RDE Measurement

After the preparation, the RDE was immersed in 0.1 M perchloric acid aqueous solution. With rotating the RDE at 1,600 rpm, linear sweep voltammetry (LSV) was carried out thereon. At this time, as the 0.1 M perchloric acid aqueous solution, one into which oxygen gas was bubbled in advance at a flow rate of 30 mL/min for 30 minutes or more, was used.

The process of the LSV is as follows. First, a potential was repeatedly swept in a range of from 1.05 V to 0.05 V (vs. RHE) at a sweep rate of 10 mV/sec. The sweep was repeated until the current values at 0.9 V (vs. RHE) and 0.35 V (vs. RHE) became stable. Then, from the thus-obtained linear sweep voltammogram reduction wave, the current value at 0.9 V (vs. RHE) was determined as oxygen reduction current value (I_{0.9}), and the current value at 0.35 V (vs. RHE) was determined as diffusion limited current value (Iₗᵢₘ). From these current values, an activation controlled current value (Ik) was obtained based on the following formula (2).

The catalytic activity per unit mass of platinum (A/g-Pt) was calculated by dividing the activation controlled current value (Ik) by the platinum amount (g) applied onto the RDE.

Ik=(Iₗᵢₘ×I_{0.9})/(Iₗᵢₘ−I_{0.9}) Formula (2)

(In the formula (2), Ik is activation controlled current (A); Iₗᵢₘ is diffusion limited current (A); and I_{0.9} is oxygen reduction current (A).)

FIG. 13 is a bar graph comparing the mass activities of the carbon-supported catalysts of Example 2 and Comparative Examples 2 and 3.

According to FIG. 13, while the mass activity of Comparative Example 2 is 630 (A/g-Pt) and that of Comparative Example 3 is 500 (A/g-Pt), the mass activity of Example 2 is 685 (A/g-Pt). Therefore, the mass activity of Example 2 is at least 55 (A/g-Pt) higher than those of Comparative Examples 2 and 3.

The fact that the mass activity of Example 2 is 55 (A/g-Pt) or more higher than Comparative Examples 2 and 3 is very important from a practical viewpoint. In today's fuel cell technology for vehicles, it is said that 50 to 100 g of platinum is used per vehicle. Therefore, the difference of 55 (A/g-Pt) in the carbon-supported catalyst results in a current value difference of (55 (A/g)×(50 to 100 (g-Pt))=) 2,750 to 5,500 A in a vehicle. Therefore, the difference of 55 (A/g-Pt) in the carbon-supported catalyst appears as an extremely large current value difference in a vehicle.

### 3. Conclusion of Catalyst Evaluation

According to the above-described catalyst evaluation by the potentiometric titration, while it was evaluated that there is almost no impurities, functional groups, etc., on the surface of the carbon-supported catalyst of Example 1, it was evaluated that there are impurities, functional groups, etc., on the surface of the carbon-supported catalyst of Comparative Example 1. Meanwhile, according to the above-described MEA evaluation, it is clear that the voltage of the MEA of Example 1 is 0.012 V higher than the MEA of Comparative Example 1.

According to the above-described catalyst evaluation by the potentiometric titration, it was evaluated that the amount of the impurities, functional groups, etc., on the surface of the carbon-supported catalyst gets smaller in the order of Example 2, Comparative Example 2 and Comparative Example 3. Meanwhile, according to the above-described RDE evaluation, it is clear that the mass activity gets larger in the order of Example 2, Comparative Example 2 and Comparative Example 3.

Therefore, it is clear that the catalyst activity evaluation by the potentiometric titration is a highly-accurate evaluation method that is able to derive the same conclusion as conventional catalyst activity evaluation methods such as MEA evaluation and RDE evaluation. It is also clear that the catalyst activity evaluation by the potentiometric titration is a method that can predict catalyst performance more easily and quickly than the evaluation methods using there conventional technologies.

### REFERENCE SIGNS LIST

1. Titration container
2. Thermostat bath
3. Stirrer
4. Stirrer bar
5. Catalyst suspension
6. pH electrode
7. Comparative electrode
8. Temperature sensor
9. Burette
10. Titrated acid solution
11. Nitrogen gas line
12. Nitrogen bubbles
100. Titrator

1. A carbon-supported catalyst,
wherein the carbon-supported catalyst comprises fine catalyst particles, each of which comprises a palladium-containing particle and a platinum-containing outermost layer covering the palladium-containing particle, and a carbon carrier on which the fine catalyst particles are supported;
wherein the carbon-supported catalyst is produced through the synthesis of the fine catalyst particles by (1) preparing the carbon carrier on which the palladium-containing particles are supported, (2) depositing a copper monatomic layer on the palladium-containing particles by copper underpotential deposition, and (3) substituting the copper monatomic layer with the platinum-containing outermost layer;
wherein, in a titration curve obtained by a potentiometric titration method in which a potential is measured by adding an acid solution drop by drop to a mixture of the carbon-supported catalyst and an alkali solution, an amount of change in the potential with respect to an amount of the acid solution added drop by drop in a range where the potential is 0.095 to 0.105 V (vs. Ag/AgCl) is 0.8 (dV/d (mL/m²)) or more; and
wherein a total surface area of the carbon-supported carrier used for the potentiometric titration method is 20 m².

2. The carbon-supported catalyst according to claim 1, wherein, in the titration curve, the amount of change in the potential with respect to the amount of the acid solution added drop by drop in a range where the potential is 0.080 to 0.120 V (vs. Ag/AgCl) is 0.8 (dV/d (mL/m²)) or more.

3. The carbon-supported catalyst according to claim 1, wherein, in the titration curve, the amount of change in the potential with respect to the amount of the acid solution added drop by drop in a range where the potential is 0.050 to 0.150 V (vs. Ag/AgCl) is 0.8 (dV/d (mL/m²)) or more.

4. The carbon-supported catalyst according to claim 1, wherein, in the titration curve, the amount of change in the potential with respect to the amount of the acid solution added drop by drop in a range where the potential is −0.020 to 0.020 V (vs. Ag/AgCl) is 2 (dV/d (mL/m²)) or more.

5. The carbon-supported catalyst according to claim 1,
wherein the alkali solution is a mixed solution of 99.5% ethanol and an alkali aqueous solution which is obtained by mixing a 0.1 M KNO₃ aqueous solution and a 0.5 M KOH aqueous solution;
wherein a pH of the alkali aqueous solution is 12; and
wherein a molar ratio of water and ethanol in the alkali solution is water:ethanol=4:1.

6. The carbon-supported catalyst according to claim 1, wherein a solution temperature of the alkali solution is 25° C. at the time of conducting the potentiometric titration method.

7. The carbon-supported catalyst according to claim 1, wherein an inert gas is bubbled into the alkali solution.

8. The carbon-supported catalyst according to claim 1, wherein the acid solution is 0.05 M sulfuric acid.
